(19) United States
(12) Patent Application Publication
(10) Pub. No.: US 2005/0105980 A1
(43) Pub. Date: May 19, 2005

(54) I-joist hole cutting apparatus

(76) Inventor: John D. Davis, Las Vegas, NV (US)

Correspondence Address: Johannes Schneeberger, 384 Panoramic Hwy, Mill Valley, CA, 94941, US

(21) Appl. No.: 11/023,028

(22) Filed: Dec. 23, 2004

Related U.S. Application Data
(63) Continuation-in-part of application No. 10/788,669, filed on Feb. 27, 2004, now Pat. No. 6,857,831.
(60) Provisional application No. 60/451,225, filed on Feb. 28, 2003.

(51) Int. Cl. B23B 51/00

(52) U.S. Cl. 408/199

(57) ABSTRACT

A hole saw for cutting standardized holes in the web portion of an I-joist features a light weight saw body having a flywheel configuration and preferably three inserted cutting blades fixed within clamp cavities in an offset to the circumference, which is dimensioned in accordance to standard web heights. The flywheel configuration provides for smooth operation at high rotational speeds in combination with intermittent actuation of the circumferentially arrayed cutting blades.

### CROSS REFERENCE

The present application is a Continuation In Part of the U.S. application of the same title and same Inventor, application Ser. No. 10/788,669, which claims priority to the Provisional Application No. 60/451,225 filed Feb. 28, 2003. The present application cross references the concurrently filed application of the same inventor titled “Quick release arbor”, Attorney Docket No. MMC1051US, which is hereby incorporated by reference.

### FIELD OF INVENTION

The present invention relates to hole saws. Particularly, the present invention relates to hole saws for cutting holes in a in comer regions with spacing requirements such as a web portion of an I-joist.

### BACKGROUND OF INVENTION

I-joists are structural elements increasingly utilized in architectural constructions and the like. I-joists are beams that have an I like profile to provide maximum stiffness and strength while keeping its weight to a minimum. I-joists are commonly fabricated in a number of dimensional standards from wood and wood like materials.

Architectural constructions often require the cutting of holes into the web portion of the I-joist to lay pipes, electrical lines and the like across one or more installed I-joists. There exist a number of standards for maximum hole sizes that may be cut into the web portion. Of primary concern is thereby a remaining offset between the web hole and the horizontal top and bottom portion of the I-joist in order to keep the I-joist's buckling tendency within safe limits. Therefore there exists a need for a hole cutting apparatus that provides spacing between adjacent sticking out structures such as the top and bottom chords while cutting the hole. The present invention addresses this need.

The cutting of large diameter holes at the construction site is mainly accomplished by hand held power tools in which the cutting apparatus is rotatable held. Therefore, for cutting large diameter holes there exists also a need for a cutting apparatus that provides cutting action with minimum friction, reduced peak torque and safe operation without pronounced or sharp features extending beyond the circumference of the rotating apparatus. The present invention addresses also these needs.

With increasing diameter of the cut hole, operational torque increases as well. At the same time, sudden tool locking poses an increasing risk for excessive operational torque peaks that may rip the power drill out of the operator's hands. Sudden tool locking is well known to occur for example at the moment when the cutting blades partially exit on the opposite side of the web shortly before completion of the cut operation. Therefore there exists a need for a configuration of a hole cutting apparatus to minimize the risk of excessive sudden operational torque peaks. The present invention addresses also this need.

Also with increasing diameter and for a limited feasible operational torque commonly associated with a hand held power drill, the cutting force of the cutting members may be insufficient to continuously remove material from the cutting groove with a circumferentially continuous cutting member as are common in prior art hole saws. In addition, saw dust may clog up the cutting members hampering the cutting action while increasing the friction in the cutting groove. Further more, circumferentially continuous cutting members make prior art hole saws increasingly instable with increasing cut diameter limiting their operational speed and requiring precise perpendicular orientation to the surface where the hole is to be cut. Both limited operational speed and precise orientation are difficult to maintain with a handheld power drill especially at construction sites where holes may have to be cut at overhead locations. Therefore, there exists a need for a hole cutting method and apparatus, that provide feasible cutting of holes of up to 12.5 inches and above into wood and wood like materials irrespective of a limited operational torque. The present invention addresses also this need.

### SUMMARY

Cutting holes with a hand held power drill or the like may be accomplished in combination with a hole cutting apparatus concentrically attached to a rotating portion of the power drill. As the hole diameter increases, the resulting torque increases as well. A hole cutting apparatus in accordance with the preferred embodiment of the invention has a number of circumferentially arrayed cutting members configured to keep cutting forces and a resulting cutting torque to a minimum for a given cutting diameter, given axial cutting pressure and a given material of the work piece.

The hole cutting apparatus is preferably configured for cutting holes with a diameter between 4 and 12.5 inches into wood and wood like materials. The hole cutting apparatus has a body and a number of groove cutting members concentrically and individually fixed with respect to the hole savs operational rotation axis. The body has a rim and a central connecting structure connecting a central arbor with the rim. The arbor is preferably configured for chucking the hole cutting apparatus in a power drill as described in the cross referenced application. The body has a flywheel configuration to minimize operational load torque peaks commonly affiliated with sudden tool locking.

The central connecting structure may further be configured to withstand an operational tilt torque affiliated with a wobbling cut movement while keeping the overall weight of the body to a minimum. The wobbling cut movement may be practiced by the operator of the power drill such that the cut members only partially engage along the groove bottom. Depending on the body's diameter, the connection structure may feature spokes.

The flywheel configuration includes either or both of a peripheral mass agglomeration and a radial mass step-up for a maximum polar moment of inertia of the lightweight body. The peripheral mass agglomeration may be for small diameter bodies between an outer radius of a clamp cavity and the bodies' circumference. The clamp cavity may assist in fixing the groove cutting elements. With increasing body diameter, the peripheral mass agglomeration becomes more prominent within the radial boundaries of the rim. The radial mass step-up is for small diameter bodies mainly along an outward clamp cavity radius.

With increasing body diameter, the connecting structure may feature increasingly distinct spokes connected at a central portion. The radial mass step-up becomes thereby more prominent between the connecting structure and the rim.

The hole cutting apparatus has a lightweight body preferably monolithically fabricated from aluminum or aluminum alloy. The central portion is preferably configured as a damp body preferably sandwiched between a tightening feature and a body of the arbor. The arbor in turn serves for attaching the apparatus to the power drill or the like. A pilot drill is attached on the opposite side in coaxial alignment with the arbor. The pilot drill drills a pilot hole into the work piece such that the apparatus is centered during the following hole cutting. The pilot drill extends sufficiently beyond the cutting members to drill the pilot hole sufficiently deep before the cutting members contact the work piece. As the rotating apparatus is forced towards the work piece, cutting edges of the cutting members gradually remove material along an increasingly deep concentric groove until a portion of the work piece inside the concentric groove becomes separated from the remaining work piece.

In the preferred embodiment, the apparatus is configured in combination with dimensional standards of an I-hoist. With respect to the present invention, an I-joist is defined as an I-beam profile having a top chord, a bottom chord and a central web portion. The apparatus provides a cutting of holes in the web portion in accordance with dimensional safety criteria for maximum hole dimensions in the web. The safety criteria are established by I-joist manufacturers for their respective products. Particularly, the ring portion of the apparatus has an outer diameter that corresponds to a height of the web portion between the chord elements such that the apparatus becomes aligned between the top chord and the bottom chord prior to a contacting of the pilot drill with the web portion. The cutting members are in an offset to the ring diameter such that the cutting groove and consequently the hole edge remain in a certain distance to the chords in accordance with the safety criteria.

In the preferred embodiment, three cutting members are circumferentially arrayed to provide an even distribution of cutting pressure onto the individual cutting members while actuating in an intermittent fashion during rotation of the hole saw apparatus. For an I-joist made of wood and/or wood like material, the cutting members may be made of steel, carbide or other material suitable for cutting wood and/or wood like material. The cutting members are preferably mounted in an exchangeable fashion for easy replacement.

### BRIEF DESCRIPTION OF THE FIGURES

FIG. 1 shows a perspective view of a first embodiment of the invention.

FIG. 2 illustrates a side view of the apparatus of FIG. 1 in operational approach to a preferred work piece.

FIG. 3 depicts a perspective view of the apparatus of FIG. 1 and the work piece of FIG. 2 after cutting a hole with the apparatus into the work piece.

FIG. 4 shows a perspective view of a second embodiment of the invention.

FIG. 5 is a top view of the apparatus of FIG. 4.

FIG. 6 is a detailed section view of the apparatus of FIG. 4 in accordance with a section line A-A indicated in FIG. 5.

FIG. 7 is a perspective view of an I-joist and a hole cutting apparatus schematically depicting the wobbling cut movement.

FIG. 8 is a perspective view of an exemplary 4.5 inch body of a hole cutting apparatus.

FIG. 9A is a front view the body of FIG. 8 with a number of reference radii referenced in FIG. 9B.

FIG. 9B is a schematic radial mass distribution plot and a polar inertia distribution plot corresponding to the body of FIG. 9A.

FIG. 10 is a perspective view of an exemplary 13 inch body of a hole cutting apparatus.

FIG. 11A is a front view the body of FIG. 10 with a number of reference radii referenced in FIG. 11B.

FIG. 11B is a schematic radial mass distribution plot corresponding to the body of FIG. 11A.

### DETAILED DESCRIPTION

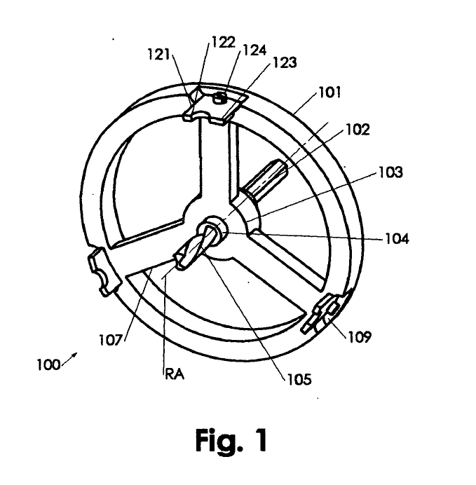

Referring to FIG. 1, the present invention is a hole cutting apparatus 100 configured to be attached to a rotating portion of a well known power drill. The power drill may be substituted by other well-known devices configured for receiving and rotating other well known apparatus performing rotating operations. The apparatus 100 is axially attached via an arbor 102, a chucking shaft of which may have a hexagonal shape for a rigid interlocking with a three jaw-clamping device of the power drill. The arbor 102 may have other configurations as are well known in the art for transmitting a torque while keeping the apparatus 100 aligned with respect to its rotation axis. Preferably the arbor has a configuration as described and claimed in the cross referenced application.

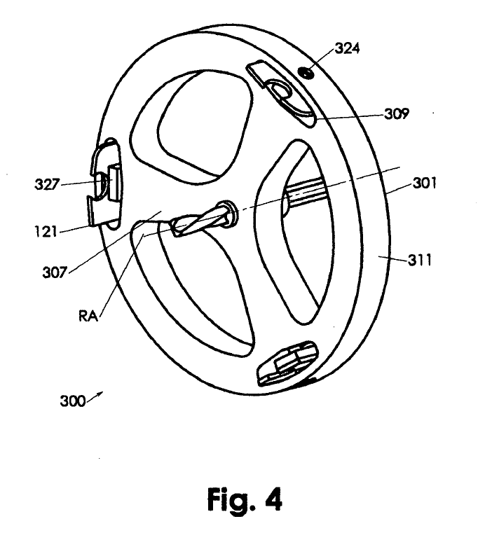

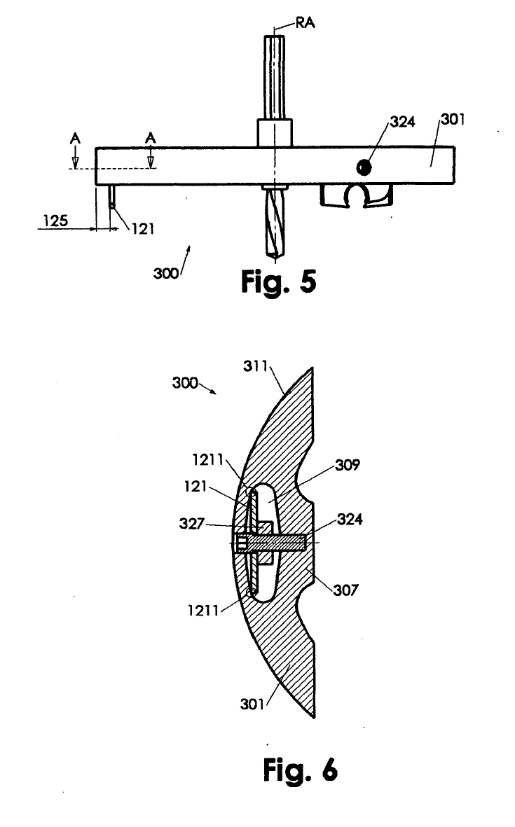

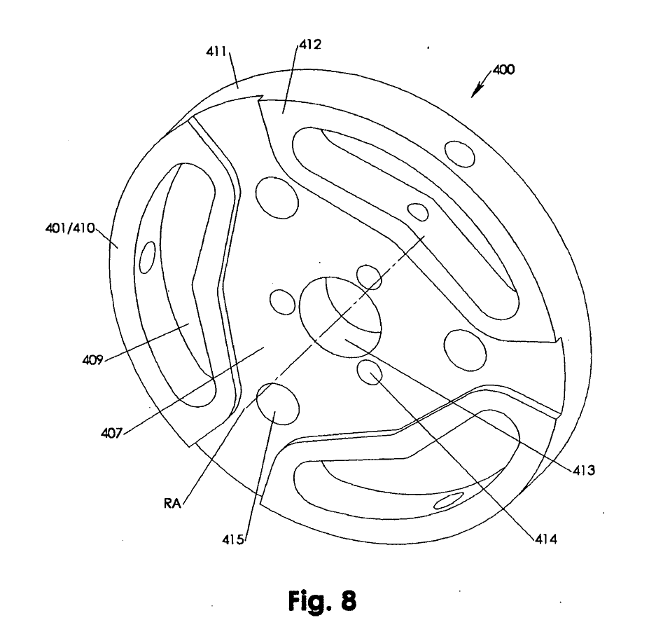

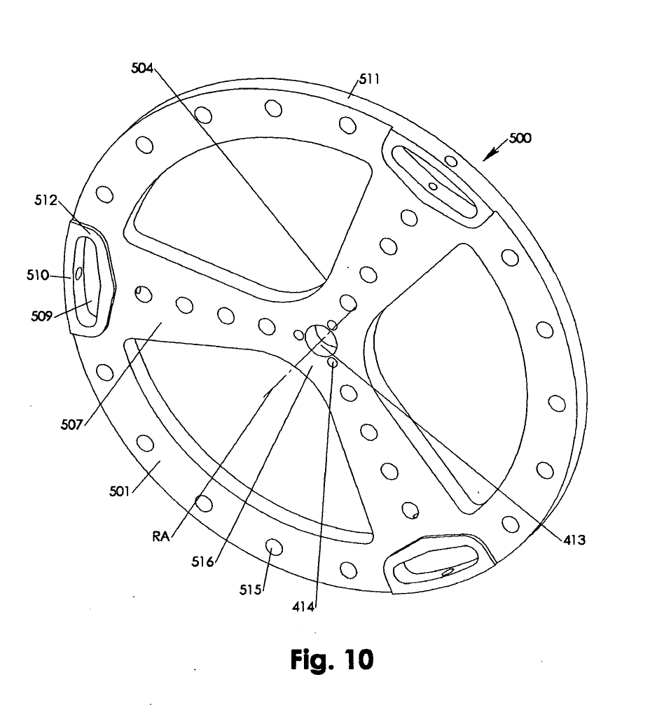

The arbor 102 extends from the backside of a central portion 103 from which preferably three eventual beams or spokes 107 extend in radial direction. The radial beams or spokes 107 connect the central portion 103 with a circumferential ring or rim 101. The central portion 103 and the radial beams or spokes 107 are part of a connecting structure connecting the arbor 102 with the rim 101. The connecting structure and the rim form a lightweight body that is preferably fabricated in a range between 4.5 and 13 inch diameter. With increasing diameter of the body, the spokes 107 are employed with more prominent shape providing a stiff connection between the rim 101 and the central portion 103 withstanding operational torque and a tilt torque resulting from the wobbling cut movement while keeping the over all weight of the apparatus 100, 300 (see also FIGS. 4-9A, 10, 11A) to a minimum.

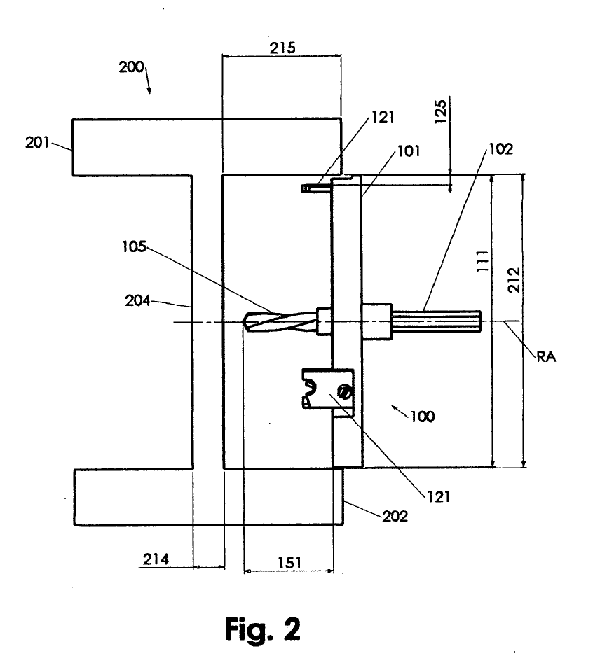

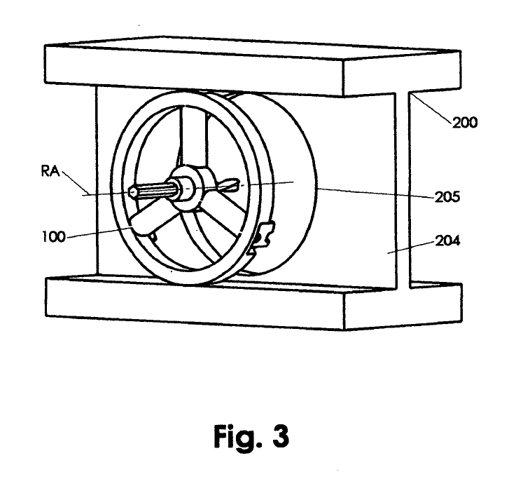

From the front side of the central portion 103 extends a pilot drill 105, which is in axial alignment with the arbor 102. An optional spacer 104 may provide a safety space between the pilot drill 105 and the central portion 103 to prevent an inadvertent contacting of the central portion 103 and/or the spokes 107 and/or the rim 101 with a work piece 200 (see FIGS. 2, 3).

Along the rim 101 are circumferentially arrayed and attached a number of groove cutting members 121, which are configured to intermittently actuate and gradually remove material from the work piece 200 while keeping friction in the cutting groove to a minimum and while preventing sudden biting of a cutting edge 122 in the cutting groove. For that purpose, the cutting members 121 have a sliding feature 123 placed in front of the cutting edge 122 with respect to an operational rotation direction of the apparatus 100.

There are preferably three groove cutting members 121 arrayed on the ring 101 to assure contact pressure being equally distributed between the individual cutting members 121 and the work piece 200. The cutting members 121 are preferably attached in a removable fashion in recesses or cavities 109 of the rim 101 and radially fixed via cap screws 124. Hence, when the cutting members 121 suffer damage or wear, they may be quickly replaced. The invention includes embodiments in which the cutting members 121 are integral part of the ring 101, which in turn may be replaceable as a whole. The groove cutting members are substantially concentrically with respect to an operational rotation axis RA.

Now turning to FIG. 2, the preferred operation of the apparatus 100 may be explained in more detail. The apparatus 100 is preferably configured for cutting holes 205 (see FIG. 3) in a web 204 of an I-beam 200 made of wood and/or wood like material. The I-beam 200, also known as I-joist 200 has a top chord 201 and a bottom chord 202. Both chords 201, 202 are spaced apart with distance 212, which equals the free height of the web 204. The rim 101 has an outer diameter or circular circumference 111 that is marginally smaller than distance 212. Consequently, the apparatus becomes vertically substantially aligned once the rim 101 is moved in between the chords 201, 202. The circular circumference 111 is sufficiently small to prevent excessive friction between the rotating rim 101 and a chord 201 and/or 202.

The pilot drill 105 protrudes above the rim 101 with an extension 151, which is sufficiently small to assure positioning prior to contacting of the pilot drill 105 with the web 204. During operation, the apparatus 100 is brought into rotation via the arbor 102 and brought into contact with the web 204 at a predetermined location. Since the rim 101 assures vertical alignment, the operating person may focus mainly on contacting the pilot drill 105 at a proper longitudinal position along the I-joist 200.

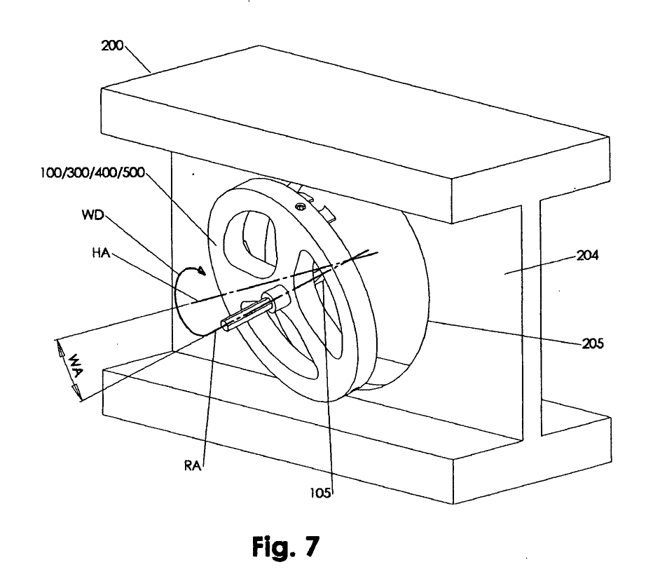

The drill extension 151 is selected such that the pilot drill 105 drills a sufficiently deep guiding hole into the web 204, before the cutting members 121 begin gradually removing material and thereby forming an increasingly deep concentric cutting groove. Due to the short circumferential length of the cutting members 121, chip buildup and associated friction between the cutting members 121 and the cutting groove is kept to a minimum. In addition, the hole cutting apparatus 100, 300 may be operated with a wobble movement as described under FIG. 7 in the below.

While axial pressure is applied via the arbor 102, the cutting members 121 continue to gradually remove material from the cutting groove until a central portion of the web 204 inside the cutting groove becomes disconnected from the remainder of the web 204. The cutting members 121 have a height selected in correspondence with a thickness 214 of the web 204 to assure a cutting groove sufficiently deep for separating the central web portion.

The cutting members 121 are positioned in an offset 125 substantially equal to the rim's 101 circular circumference 111. The offset 125 is selected according to hole cutting standards established by a manufacturer of I-joist 200. The I-joist 200 may be fabricated in a number of standardized dimensions including a variety of standardized widths 212. The apparatus 100 may be provided in varying configurations that comply with the varying I-joist standards. As a result, the apparatus 100 may be selected in a prefabricated configuration that corresponds to the dimensional standard of the I-joist 200 for cutting a hole 205 (see FIG. 3) that is within the static safety limits for that particular joist 200.

To further reduce friction between the ring 101 and a chord 201 and/or 202, the outer surface of the ring 101 may be specially treated for reduced friction. Such treatment may include a coating with a low friction material such as Teflon.

The present invention includes embodiments in which a bushing ring or a bearing may be assembled on the rim 101. In that case, the circular circumference 111 would be that of the bushing or the bearing.

The present invention is not limited to cutting holes into wooden and/or wood like I-beams. It may also be configured for cutting holes with reduced friction into any kind of work piece. For example, holes may be cut with the apparatus 100 into a metal or stone. In such cases, the cutting members 121 may be accordingly configured for cutting metal or stone as is well known in the art.

In the first embodiment of the invention depicted in the FIGS. 1-3, the circular circumference 111 is substantially continuous, which warrants a smooth sliding of the rim 101 against adjacent chords 201, 202 during cutting operation. In context with the present invention, the substantially continuous circular circumference 111 pertains to the fact that a projection of the circular circumference 111 in axial direction renders a substantial continuous circle, despite recessing cavities 109.

In a second embodiment of the invention depicted in the FIGS. 4-6, the circular circumference 311 has s substantially continuous surface, which means that all main outside boundary edges of the continuous surface are substantially circular and substantially concentric. Cap screws 324 may be accessible through radial rim openings that are not considered as outside boundary edges due to their insignificantly small diameters. The substantially continuous surface provides increased operational safety preventing inadvertent radial thump in case of premature rotation of the apparatus prior to operational positioning of the apparatus 300.

An additional safety aspect is the fact that the groove cutting members 121 are fixedly held in cavities 309 that are finite in other than axial direction. Particularly, the cavities 309 are finite in direction radial away from the axis of rotation. Under extreme conditions, where the attachment of the groove cutting members 121 may suffer from impact or the like, the groove cutting members 121 would be held in the apparatus 300 against centrifugal forces.

FIG. 6 illustrates in detail how the groove cutting members 121 are fixedly held in the apparatus 300 via the cap screw 324 radially withholding itself in a press contact in one of the spokes 307 while pressing the groove cutting member 121 against an outside radial wall of the cavity 309. The cap screw 324 is reaching thereby through an opening of the groove cutting member 121 such that the cap screw 324 head is peripherally accessible through the radial rim opening. The cap screws 324 act thereby additionally as a double supported latch holding with their shaft and head their respective groove cutting members 121 in the cavity 309. The cap screw 324 may reach into a radial inward hole of the cavity 309 as depicted in FIG. 6 or may push direct against the inside wall of the cavity 309.

In contrast, the groove cutting members 121 are pressed in the first embodiment against an inside radial wall of the cavity 109. Also, the cap screws 124 are withholding them self in a tensile fashion, which may require threads in the spokes 107.

The cap screws 324 are preferably pressing their associated groove cutting members 121 via a nut 327 that has a circumferential locking contour corresponding to a rotation lock feature of the cavity 309. The circumferential locking contour is preferably a flat surface corresponding to a flat bottom of cavity 309 in assembled position. In that case, a flat bottom of the cavity 309 may serve as the circumferential locking contour.

Also in the second embodiment, the groove cutting members 121 may be pressed against the outside radial wall with two bridge contacts 1211 that are in an opposing distance relative to the cap screw 324 such that the groove cutting members 121 are resiliently deflected. This assists in establishing a resilient fix of the groove cutting members 121 that absorbs operational vibrations without becoming loose. Alternately, the curvature of the groove cutting members 121 may be fabricated accordingly such that it may correspond to the cut groove radius in assembled position.

Rims 101, 301, spokes 107, 307 and central portions 103, 303 are preferably monolithically fabricated from a lightweight material such as for example, an aluminum alloy, an magnesium alloy, an injection molded plastic or from sheet metal.

The hole cutting apparatus 100, 300 may be fabricated in accordance with exemplary standard diameters for circular circumference 111, 311 listed in inches in the table below.

4.5
5
5.5
6
6.5
7
7.5
8
8.5
9
9.5
10
10.5
11
11.5
12
12.5
13.0

The preferred offset 125 is about 0.25 inches making the cut holes in diameter approximately 0.5 inches smaller than the circular circumference 111, 311. An additional spacer insert may be placed in between the groove cutting member 121 and the respective outside wall to slightly reduce the diameter of the cut hole. Such spacer insert would have a preferred thickness of about 0.125 inches.

Referring to FIG. 7, the hole cut apparatus 100, 300 may be actuated in a wobbling cut movement by tilting the rotation axis RA in a wobble angle WA with respect to a hole axis HA while the rotation axis RA is gradually rotated in wobble direction WD around the hole axis HA. The hole axis HA is the center axis of the cut hole 205 defined in its position by the initial drilling of a centering hole with the pilot drill 105. The hole axis HA is perpendicular to the web 204.

Once the pilot hole is drilled with the rotation axis RA perpendicular to the web 204, the operator may tilt the rotating hole cut apparatus 100, 300 into the wobble angle WA and may start to wobble the hole cut apparatus 100, 300 in wobble direction WD around the hole axis HA while slightly pushing the hole cut apparatus towards the web 204. The hole cut apparatus is thereby preferably rotated with maximum rotational speed provided by the power drill. Due to a flywheel configuration of the hole cut apparatus' 100, 300 body, the cutting members 121 engage smoothly at a fractional cut area along the cutting circumference 205 irrespective the wide angular gaps between the individual cut members 121. The flywheel body acts thereby as a gyro spatially stabilizing the rotation axis RA against vibrating cut forces that otherwise may induce tilting vibrations onto the power drill.

As a result of the fractional cut area, the cutting members 121 engage one by one in short consecutive intervals at the bottom of the progressing cutting groove. The operational torque continuously pumped by the power drill into the body's kinetic flywheel energy is thereby consumed in short cut intervals. Sufficient cut force is consequently available during the cut intervals irrespective the large cut radii and irrespective the limited operational torque.

Another advantage of the wobbling cut movement is a varying engaging depth of the cutting members 121 along the progressively deep cutting groove. This in combination with the wobbling movement WD has a certain self cleansing effect in which saw dust is expelled from the cutting groove before it may heat up due to friction and bake onto the cutting members 121. This is particularly important because of the relatively large cutting speeds resulting from the large cut radius and a relatively large content of binding agents in the web's 204 material.

From the teachings presented under FIG. 7, the significance of the body's flywheel configuration for a feasible cutting of large diameter holes with limited operational torque becomes apparent to anyone skilled in the art. The flywheel configuration of the body includes peripheral mass agglomeration and/or outward radial mass up-step, both well known in the art of designing lightweight flywheels. The present invention includes bodies having an overall diameter preferably between but not limited to 4.5 inches and 13 inches. Due to the wide diameter range of the body, rim 101, 301, 401, 501 and central connecting structure may be configured varyingly especially to comply with design constraints for fixing the cutting members 121 and for connecting to the arbor 102. It is noted that 4.5 inch and 13 inch are exemplary values in conjunction with the body's 400, 500 detailed description to illustrate the proportion of design bandwidth embodied in the present invention including the body's flywheel configuration. It is clear to anyone skilled in the art that the body 400 may be smaller or larger than 4.5 inch diameter as well as the body 500 may be smaller or larger than 13 inch diameter without departing from the scope of the invention.

The bodies 400, 500 may be part of the hole cut apparatus 300 and are exemplarily presented for describing the aspects of flywheel configurations. It is well understood that a flywheel configuration as described in the below with peripheral mass agglomeration and outward radial mass step-up may be applied to the body of the hole cut apparatus 100, 300 and their equivalents.

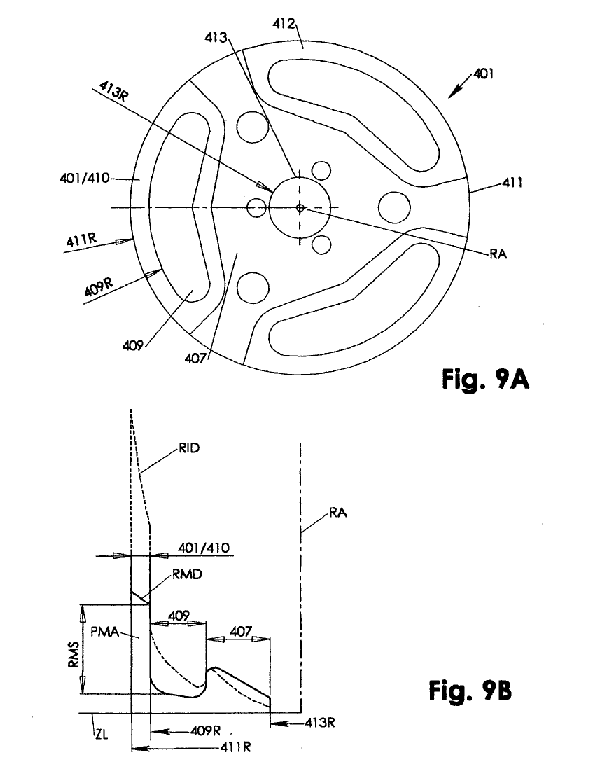

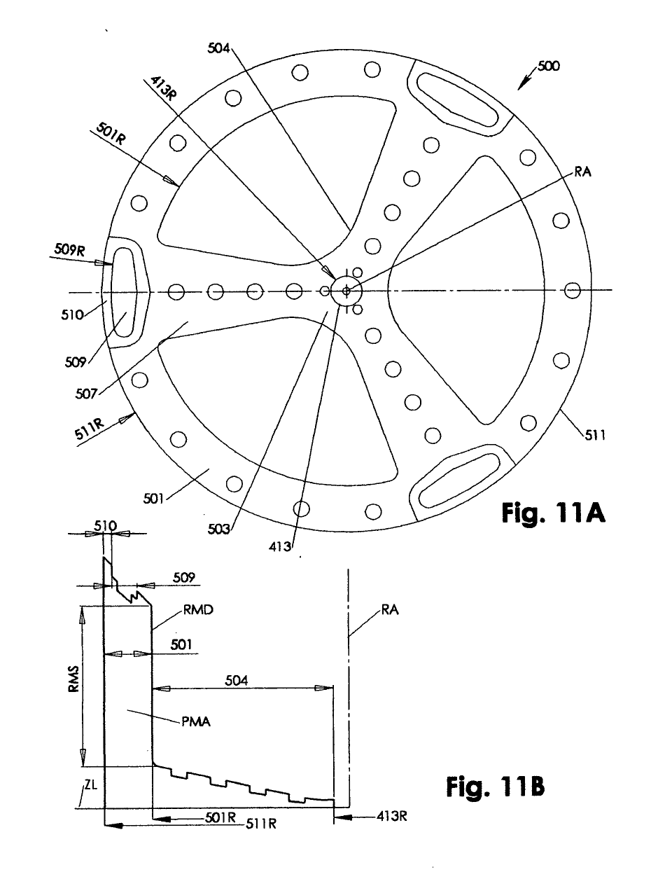

The flywheel configuration of the body 400, 500 is schematically plotted in the FIGS. 90 and 11B. The solid curve illustrates radial mass distribution relative to the rotation axis RA. The dashed curve of FIG. 9B additionally depicts polar inertia distribution, which is the well known product of each mass element times the square of that mass element's radius relative to the rotation axis RA. The areas encompassed by the curves RMD represents the total masses of the body 400, 500. The area encompassed by the curve RID and the zero line ZL represent the total polar moment of inertia of the body 400. The curves RMD and RID extend between the core shaft radius 413R and the circumference 411R, 511R.

The graphs of FIGS. 9B, 11B a peripheral mass agglomeration PMA and an outward radial mass step-up RMS as part of the flywheel configuration. The graphs of FIGS. 9B, 11B are depicted for the sole purpose of general understanding of peripheral mass agglomeration, outward radial mass step-up as defining elements of the body's flywheel configuration without claim for accuracy and/or completeness.

The area of the body 400 with a minimum circumference 411R is mainly occupied by the clamp cavities 409 and structure of the connecting structure 407 required for fixedly holding the cutting members 121 as taught in FIG. 6. Cavities 409 have an extension sufficient to provide space for cutting members 121 and the affiliated tightening elements such as screw 324 and nut 327. The connecting structure 307 provides for embedding the shaft of screw 324. The connecting structure 307 may feature a core shaft 413 and pin holes 414. For a more detailed description of core shaft's 413 and pin holes' 414 function it is referred to the cross referenced application. The connecting structure 307 is free of spokes due to the limited real estate.

The outward radial mass step-up RMS of the body 400 is substantially along outer radius 409R of the clamp cavities 409. The peripheral mass agglomeration of the body 400 is substantially between the outer cavity radius 409R and the circumference 411R. The outward cavity barrier 410 is at the same time the rim 401 which is the preferred structural element providing the peripheral mass agglomeration. The body 400 may have a central mass agglomeration between the core radius 413R and the radial transition zone between cavities 409 and central connecting structure 407, which have negligible influence on the flywheel configuration do to the close proximity to the rotation axis RA. The central mass agglomeration has consequently little influence on the total polar moment of inertia of the body 400 as can be seen from the radial inertia distribution RID.

The area of the body 500 with a maximum circumference 511R may be at a scale at which the damp cavities 509 consume a small portion of the available design area. Accordingly, the peripheral mass agglomeration PMA of the body 500 is substantially within an inward and an outward radial rim boundary 501R, 511R. In the preferred case of a continuous circular circumference 511 the outward rim boundary 511R coincides with the circular circumference 511. The contribution of the outward cavity barrier 510 to the flywheel configuration becomes less significant with increasing circumference 411, 511 as may be clear to anyone skilled in the art.

The central connecting structure 504 features spokes 507 and the central portion 503. The central portion 503 acts as a clamp body sandwiched with its core shaft 413 and pin holes 414 between a tightening feature and a body of the arbor 102. The spokes 507 consume only an angular fraction of the area inside the inward rim boundary 501R such that the main outward radial mass step-up RMS of the body 500 is substantially between the central connecting structure 504 and the rim 501 along the inward radial rim boundary 501R.

In the preferred case, a number of varying size bodies 400, 500 are interchangeable with a standardized arbor 102 and standardized cutting members 121. Accordingly, core shaft 413, pin holes 414 may be standardized as well as angular extension of cavities 409, 509. Cutting members 121 may be standardized as well and configured with sufficient flexibility to resiliently deflect within a range that corresponds to a minimum and a maximum of outer cavity radii 409R, 509R.

Bodies 400, 500 may feature holes 415, 515 for local material removal at low stress areas to further reduce weight as may be well appreciated by anyone skilled in the art. Around the clamp cavities 409, 509, shoulders 409, 509 may be added against local peak stresses stemming from the damp forces for fixedly holding the cutting members 121.

The total mass of body 400 made of an aluminum of 7000 series with a height of approxiametely 0.5 inch may be about 0.6 pounds with a total polar moment of inertia with respect to the rotation axis RA of about 1.6 pounds*square inches. The inertia to weight ratio is consequently about 2.66 square inches. The total mass of body 500 made of an aluminum of 7000 series with a height of approxiametely 0.5 inch may be about 3.4 pounds with a total polar moment of inertia with respect to the rotation axis RA of about 88 pounds*square inches. The inertia to weight ratio is consequently about 26 square inches. This exemplary data is provided with a commercially available solid modeling software.

The present invention includes embodiments, in which the flywheel configuration is provided additionally or exclusively by a circumferentially fixed element of a heavy weight metal removable or permanently fixed along the circular circumference 111, 311. Also the individual cutting members 121 may be combined into a ring like structure from which the cutting members 121 protrude in cutting direction.

Practical experimentation had shown that three cutting members 121 circumferentially evenly arrayed provide a most stable cutting action over a broad range of operational speed. Even though one or two circumferentially arrayed cutting members 121 may provide sufficient cutting action at high rotational speeds, they make the hole cutting apparatus performance more sensible to inadvertent speed drops as may occur as a result of excessive contact force applied by an operator. During such speed drops, the stabilizing gyro effect of the hole saw's 100, 300 flywheel configuration drops significantly causing jerky and instable operation. Cutting members 121 arrayed in numbers more than three proofed again destabilizing similar to that of a circumferentially continuous cutting member of the prior art.

Thickness of the cutting members 121 is also a main contributing factor in keeping the operational torque to a minimum. The cutting members 121 may be resiliently bent in assembled position from a naturally straight configuration into a radius conforming to the cut diameter. The resilient bending of the cutting members 121 has an advantageous stiffening effect on the cutting members 121 providing for a preferred cutting member 121 thickness of less than 0.04″. Such thin cutting members 121 in turn provide for a minimal cutting groove width and consequently for minimal material to be removed for successfully cutting a hole. 12.5″ holes were cut with a hand held power drill of about 1 kW power consumption at a rotational speed of about 3000 rpm into a ⅜″ OSB material in approximately 7 seconds. With an 18V battery powered hand held power drill the same holes were cut at about 1600 rpm in approximately 13 seconds. Accordingly, the flywheel configuration includes a design strength that resists centrifugal forces up to 3000 rpm of all involved components exposed to centrifugal forces of the hole saw apparatus 100, 300.

Accordingly, the scope of the invention described in the specification above is set forth by the following claims and their legal equivalents:

1. A hole cutting apparatus comprising a body and an circumferentially intermittent actuating groove cutting member fixed in proximity to an outside circumference of said body, wherein said hole cutting apparatus has a flywheel configuration.

2. The hole cutting apparatus of claim 1, wherein said body has a rim.

3. The hole cutting apparatus of claim 2, wherein said body has spokes.

4. The hole cutting apparatus of claim 2, wherein said rim is provided by an outward clamp cavity barrier for said fixing said groove cutting members.

5. The hole cutting apparatus of claim 1, wherein said flywheel configuration includes a peripheral mass agglomeration.

6. The hole cutting apparatus of claim 5, wherein said peripheral mass agglomeration is substantially between an outer radius of a clamp cavity of said body and said outside circumference, said clamp cavity being configured for said fixing of said groove cutting member.

7. The hole cutting apparatus of claim 5, wherein said body has a rim and wherein said peripheral mass agglomeration is substantially within an inward and an outward radial boundary of said rim.

8. The hole cutting apparatus of claim 1, wherein said flywheel configuration includes an outward radial mass step-up.

9. The hole cutting apparatus of claim 8, wherein said radial mass step-up is substantially along an outer radius of a clamp cavity of said body, said clamp cavity being configured for said fixing of said groove cutting member.

10. The hole cutting apparatus of claim 8 wherein said body has a rim and wherein said radial mass step-up is substantially along an inward radial boundary of said rim.

11. The hole cutting apparatus of claim 10, wherein said body comprises a number of circumferentially arrayed spokes.

12. The hole cutting apparatus of claim 1, wherein said hole saw body is monolithically fabricated.

13. The hole cutting apparatus of claim 1, wherein hole saw body and said cutting member are monolithically fabricated.

14. The hole cutting apparatus of claim 1, wherein said groove culling member features a sliding feature in front of a cutting feature with respect to a cutting direction of said groove cutting members.

15. The hole cutting apparatus of claim 1, wherein said groove cutting member is fixedly held in a cavity of said rim.

16. The hole cutting apparatus of claim 15, wherein said groove cutting member is fixedly held in said cavity via a cap screw radially and tensile withholding itself at said saw body while pressing said groove cutting member against an inside radial wall of said cavity, wherein said cap screw is reaching through an opening of said groove cutting member.

17. The hole cutting apparatus of claim 15, wherein said cavity is finite in other than axial direction.

18. The hole cutting apparatus of claim 17, wherein said groove cutting members is fixedly held in said cavity via a cap screw radially withholding itself in a press contact at said saw body while pressing said cutting member against an outside radial wall of said cavity, wherein said cap screw is reaching through an opening of said groove cutting member, and wherein a head of said cap screw is peripherally accessible through a radial rim opening.

19. The hole cutting apparatus of claim 18, wherein said cap screw is pressing said at least one groove cutting member via a nut having a circumferential locking contour corresponding to a rotation lock feature of said cavity.

20. The hole cutting apparatus of claim 18, wherein said groove cutting member is pressed against said outside radial wall with two bridge contacts being in opposing distance relative to said cap screw such that said groove cutting member is resiliently deflected.

21. The hole cutting apparatus of claim 1, wherein said body comprises a rim having a substantially circumferentially continuous surface.

22. The hole cutting apparatus of claim 21, wherein said continuous surface has a low friction coating.

23. The hole cutting apparatus of claim 1, wherein said body includes a clamp body sandwiched between an arbor tightening feature and an arbor body.

24. The hole cutting apparatus of claim 1, wherein said body is made of a light metal.

25. The hole cutting apparatus of claim 1, wherein said body is made of plastic.

26. The hole cutting apparatus of claim 1, wherein said flywheel configuration is provided by a circumferentially fixed element of a heavy weight metal.

27. The hole cutting apparatus of claim 26, wherein said circumferentially fixed element is a ring like structure.

28. The hole cutting apparatus of claim 27, wherein said groove cutting member is integral part of said ring like structure, and wherein said groove cutting member protrudes from said ring like structure in a cutting direction of said hole saw apparatus.

29. The hole cutting apparatus of claim 1, wherein three of said groove cutting member are circumferentially evenly arrayed in said proximity of said outside circumference.

30. The hole cutting apparatus of claim 1, wherein said cutting member has a thickness of less than 0.04 inch.

31. The hole cutting apparatus of claim 1, wherein said flywheel configuration includes a design strength of all components of said hole cutting apparatus exposed to centrifugal forces, said design strength resisting centrifugal forces of up to 3000 rpm.
